(19) United States
(12) Patent Application Publication
(10) Pub. No.: US 2023/0151691 A1
(43) Pub. Date: May 18, 2023

(54) APPARATUS TO ASSIST IN THE RAISING OR LOWERING OF A ROLLER SHADE

(71) Applicant: ZMC Metal Coating Inc., Woodbridge (CA)

(72) Inventor: Philip NG, Thornhill (CA)

(73) Assignee: ZMC Metal Coating Inc., Woodbridge (CA)

(21) Appl. No.: 18/053,555

(22) Filed: Nov. 8, 2022

Related U.S. Application Data
(60) Provisional application No. 63/279,231, filed on Nov. 15, 2021.

(51) Int. Cl. E06B 9/78; E06B 9/42

(52) U.S. Cl. CPC E06B 9/78; E06B 9/42

(57) ABSTRACT

An apparatus to assist in the raising or lowering of a roller shade. The apparatus comprises a grab plate secured or securable to a bottom bar and a wand that is releasably securable to the grab plate. The grab plate comprising a receiver to releasably receive an upper end of the wand such that when wand’s upper end is moved vertically upward the roller shade is retracted, and when the wand is moved vertically downwardly the roller shade is lowered. The receiver comprises a mating surface against which a flange on the upper end of the wand bears when the wand is moved vertically upward. The receiver further comprises a retainer into which a locking member on the upper end of the wand is seatable when the wand is moved vertically downward.

### CROSS REFERENCE TO RELATED APPLICATIONS

This patent application claims priority on and the benefit of U.S. Provisional Pat. Application No. 63/279,231 having a filing date of 15 Nov. 2022.

### BACKGROUND OF THE INVENTION

### Technical Field

This invention relates to the field of roller shades or roller blinds, and in particular to an apparatus that assists in the raising or lowering of the blind fabric.

### Prior Art

Roller shades, or roller blinds as they are sometimes referred to, have become an increasingly popular window treatment. The development of roller shades has seen manufacturers moving away from more traditional cord activation units for both aesthetic purposes and to address safety concerns surrounding potential strangulation hazards. As a result, many roller shades are now made with internal clutch and/or spring mechanisms that allow an operator to simply grab the lower bottom bar of the shade and pull it downwardly to deploy the shade or raise it to allow the shade fabric to be re-wound upon the roller tube. The clean look of such roller shades, their ease of operation, and their ease of installation, have made them increasingly popular. However, without the inclusion of a downwardly extending cord that operates the shade’s internal mechanisms, shades installed on high mounted windows (for example, in many commercial settings and in residential settings with a high ceiling height) can present difficulty for an operator when attempting to reach and grasp the shade’s bottom bar. The same difficulty can be experienced by operators of shorter status, including children.

### BRIEF SUMMARY OF THE INVENTION

Accordingly, in one aspect the invention provides an apparatus to assist in the raising or lowering of a roller shade, the apparatus comprising a grab plate that is secured or securable to a bottom bar of the roller blind; a wand that is releasably securable to the grab plate, the grab plate comprising a receiver to releasably receive an upper end of the wand such that when the upper end of the wand is moved vertically upward the roller shade is retracted, and when the wand is moved vertically downwardly the roller shade is lowered; the receiver comprising a mating surface against which a flange on the upper end of the wand bears when the wand is moved vertically upward, the receiver further comprising a retainer into which a locking member on the upper end of the wand is seatable when the wand is moved vertically downward.

In a further aspect there is provided an apparatus to assist in the raising or lowering of a roller shade, the apparatus comprising a grab plate, the grab plate secured or securable to a bottom bar of the roller blind; a wand, the wand releasably securable to the grab plate, the grab plate comprising a receiver to releasably receive an upper end of the wand such that when the upper end of the wand is moved vertically upward the roller shade is retracted, and when the wand is moved vertically downwardly the roller shade is lowered; the receiver comprising a mating surface against which a flange on the upper end of the wand bears when the wand is moved vertically upward, the receiver further comprising a retainer into which a locking member on the upper end of the wand is seatable when the wand is moved vertically downward, the locking member comprising one or more locking tabs that extend outwardly from an engagement head on an upper end of the wand.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a view of a generic window having mounted thereon a roller shade equipped with an apparatus in accordance with an embodiment of the invention.

FIG. 2 is an upper perspective view of a grab plate in accordance with an embodiment of the invention.

FIG. 3 is a plan view of the grab plate shown in FIG. 2.

FIG. 4 is a lower perspective view of the grab plate shown in FIG. 2.

FIG. 5 is an upper perspective view of a wand constructed in accordance with an embodiment of the invention.

FIG. 6 is a view of the roller shade of FIG. 1 prior to engagement of the wand with the grab plate.

FIG. 7 is an enlarged detail view of section “A” of FIG. 6.

FIG. 8 is a view of an embodiment of the invention, subsequent to FIG. 7, wherein the upper end of the wand has been received through an opening in the grab plate.

FIG. 9 demonstrates an upwardly directed force applied to the wand that is transmitted through the grab plate to the bottom bar in order to permit a raising of the roller shade.

FIG. 10 shows the roller shade of FIG. 9, having been moved to a substantially raised or retracted position, and demonstrating a rotation of the wand through approximately 90° when the upper end of the wand is received through an opening in the grab plate.

FIG. 11 is an enlarged detail view of portion “B” of FIG. 10.

FIG. 12 is a lower perspective view of FIG. 11.

FIG. 13 is a view of the roller shade of FIG. 9 showing a lowering of the shade fabric through the application of a downwardly directed force to the wand.

### DETAILED DESCRIPTION OF PREFERRED EMBODIMENTS

The present invention may be embodied in a number of different forms. The specification and drawings that follow describe and disclose some of the specific forms of the invention. With reference to the attached drawings, there will now be described a preferred embodiment of the invention.

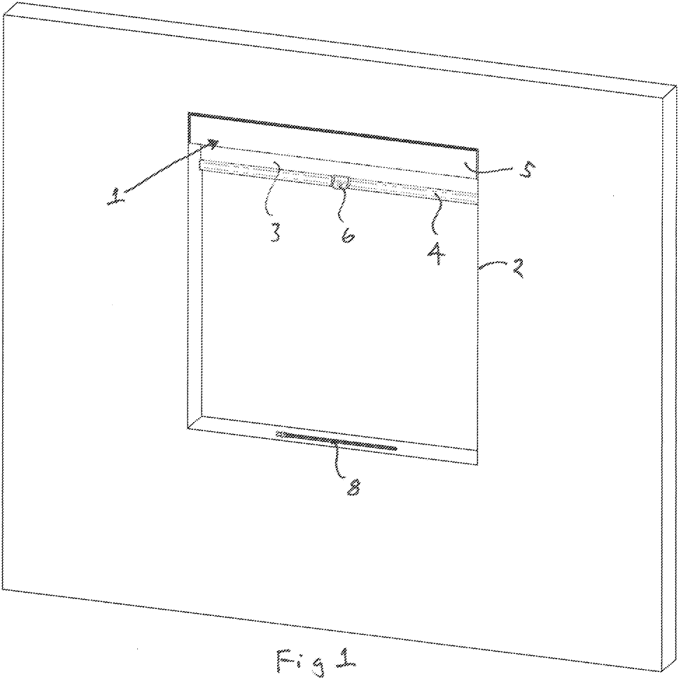

FIG. 1 is an illustrative drawing showing a roller shade 1 mounted within a window frame 2. It will be appreciated by those skilled in the art that roller shade 1 could take any one of a wide variety of different roller shades, shade configurations, or shade constructions. In the embodiment shown, shade 1 includes blind fabric 3 having mounted along a lower end thereof a bottom bar 4. FIG. 1 shows a valance 5, behind which is mounted the roller tube, mounting end brackets, and the mechanical drive/clutch/spring-assist system for the shade. In this embodiment, roller shade 1 is a cordless shade that would typically be lowered or raised by grasping bottom bar 4 and pulling it in a downward direction, or lifting it vertically.

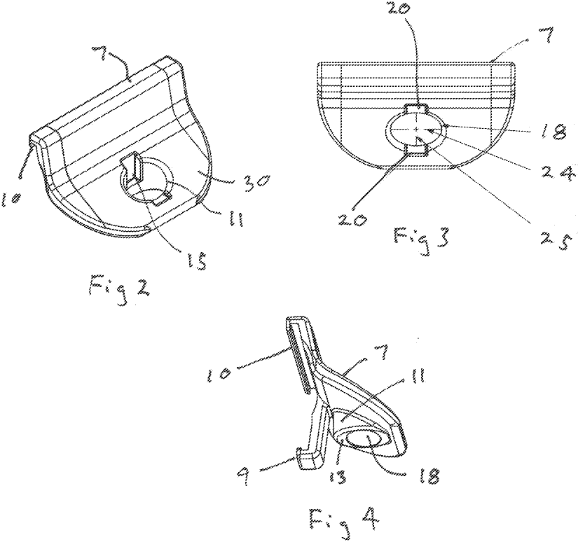

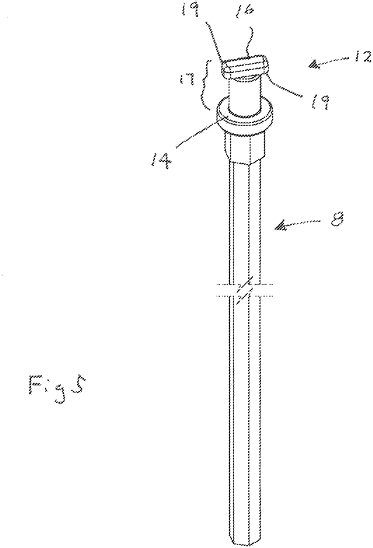

In accordance with the invention there is provided an apparatus 6 to assist in raising or lowering blind fabric 3 of roller shade 1. With specific reference to FIGS. 2 through 5, apparatus 6 is comprised generally of a grab plate 7 and a wand 8. Grab plate 7 is securable to bottom bar 4, whereas wand 8 is releasably securable to grab plate 7. In one embodiment, the grab plate may be permanently fixed to the bottom bar or may be an integral portion of the bar formed during its construction. Alternately, grab plate 7 may include a lower clip member 9 and an upper clip member 10 that are designed to reasonably secure grab plate 7 to bottom bar 4. A variety of other mechanisms could be utilized in order to releasably secure the grab plate to the bottom bar. In the embodiment shown, grab plate 7, including lower clip 9 and upper clip 10, is constructed from a flexibly resilient material (for example metal or a plastic-type of material) that permit the upper and lower clips to “snap” over the external surface of the bottom bar, releasably securing grab plate 7 thereto. It is expected that in most instances grab plate 7 will be secured to bottom bar 4 at approximately the horizontal midpoint of the bottom bar. Grab plate 7 may also include a finger tab 30 which could be grasped by an operator in instances where it may be desirable to raise or lower the blind by grasping the grab plate by hand.

Grab plate 7 comprises a receiver 11 to releasably receive an upper end 12 of wand 8, such that moving the wand vertically upward raises the roller shade or causes a retraction of blind fabric 3 onto the roller tube. Similarly, when wand 8 is moved vertically downward, the roller shade is lowered with blind fabric 3 being unwound from the roller tube. Receiver 11 may be comprised of a mating surface 13 against which a flange 14 on upper end 12 of wand 8 bears when the wand is moved vertically upward. Receiver 11 may further comprise a retainer 15 into which a locking member 16 on upper end 12 of wand 8 is seatable when the wand is moved vertically downward.

In an embodiment, upper end 12 of wand 8 includes an engagement head 17 that is received through an opening 18 within grab plate 7. Further, in one embodiment locking member 16 may comprise one or more locking tabs 19 that extend outwardly from engagement head 17. Retainer 15 may then comprise one or more slots 20 that are shaped to releasably receive the one or more locking tabs that extend outwardly from engagement head 17. Locking tabs 19 may take the form of a locking bar 21 that is positioned or secured generally perpendicular to the longitudinal axis of engagement head 17, with locking bar 21 having at least one end extending beyond an outer surface of the engagement head and seatable within one or more of slots 20. It will thus be appreciated that with such a structure, and with locking bar 21 (or a part thereof) seated in slot or slots 20, a downward force applied to the wand will be transmitted through at least one end of locking bar 20 to the grip plate, causing the roller shade to be lowered as fabric is withdrawn from about the roller tube.

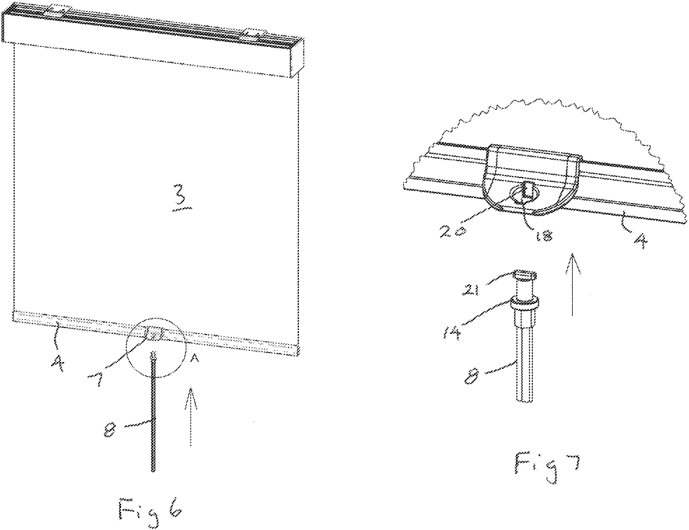

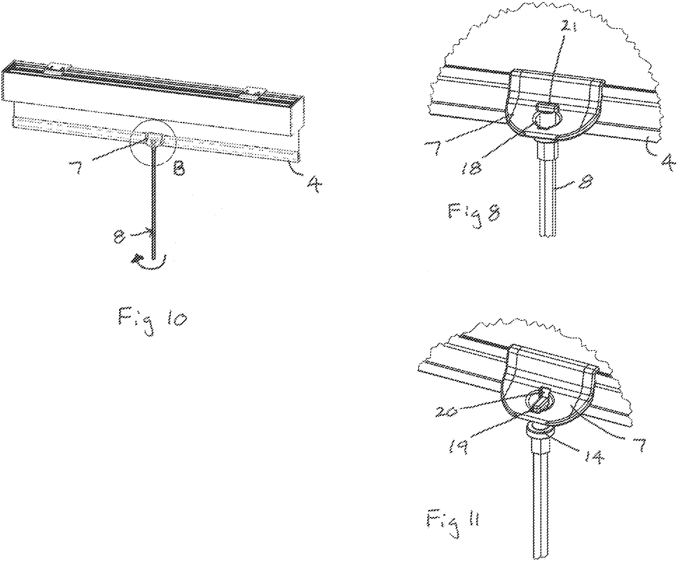

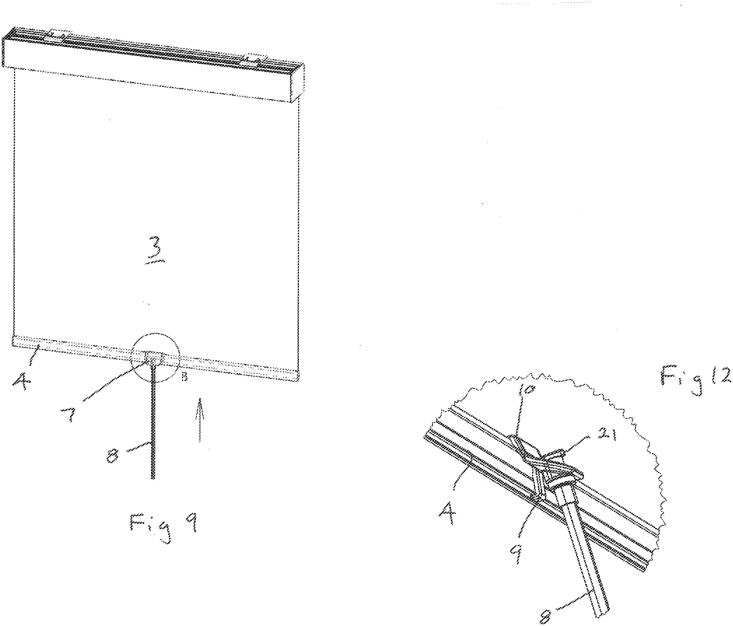

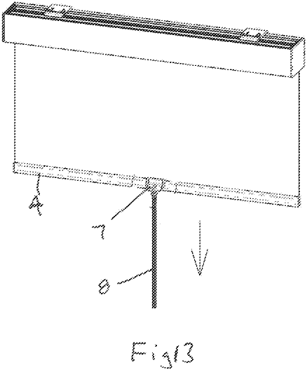

With specific reference to FIG. 3, opening 18 in grab plate 7 may be generally oval or oblong in shape with a major axis 24 and a minor axis 25, where the major axis is longer than the minor axis. The major axis is dimensioned to permit the passing of locking bar 21 through opening 18 when the locking bar is generally aligned with major axis 24 (see generally FIGS. 6-8). In this embodiment minor axis 25 is dimensioned such that it is smaller than the length of locking bar 21, preventing passage of the locking bar through opening 18 (and hence a removal of wand 8 from its engagement with grab plate 7) when the locking bar is generally aligned with minor axis 25 (see generally FIGS. 11 and 12). It will thus be appreciated that aligning locking bar 21 with the major axis of opening 18 in grab plate 7 will permit the insertion of upper end 12 of wand 8 through opening 18 and into engagement with grab plate 7. Thereafter, rotating the wand by approximately 90° will align locking bar 21 generally with minor axis 25 and prevent the removal of the wand from its engagement with grab plates 7. It should further be noted that in this configuration slots 20 within grab plate 7 are also generally aligned with minor axis 25 such that when locking bar 21 is generally aligned with the minor axis the outer ends of locking bar 21 will be received or seated within slots 20 to effectively “hang” wand 18 from grab plate 7. At that point downward force applied to the wand will be transmitted through the locking bar to slots 20, and ultimately from grab plate 7 through to bottom bar 4, in order to lower the roller shade.

In the embodiment depicted in the attached drawings, raising roller shade 1 entails the insertion of upper end 12 of wand 8 through opening 18 in grab plate 7. It will be appreciated that in this particular embodiment, to permit upper end 12 to be received through opening 18, the wand will need to be oriented in a manner that generally aligns locking bar 21 with major axis 24 (see generally FIGS. 6-9). As upper end 12 of wand 8 passes through opening 18 flange 14 will engage mating surface 13. Movement of the wand in an upward direction at that point will transfer force from flange 14 to mating surface 13, and ultimately from grab plate 7 to bottom bar 4, thereby raising the roller shade by permitting the shade’s internal structure to rewind fabric 3 back onto the roller tube. With the receipt of engagement head 17 through opening 18, there will also be provided a means to prevent an accidental dislodgement of flange 14 from its engagement with mating surface 13 as the wand is pushed in an upwardly direction.

When the roller shade is raised or lowered to its desired position, wand 8 can merely be left hanging from grab plate 7 by means of the engagement of locking bar 21 with slots 20. Alternatively, the wand can be lifted slightly to unseat locking bar 21 from slots 20, after which wand 8 can be rotated by approximately 90° to once again permit locking bar 21 to align with major axis 24, so that downward movement of the wand will allow engagement head 17 to disengage grab plate 7. The wand will then be free from attachment to the grab plate and can be stored for future use. For example, FIG. 1 shows wand 8 stored on the lower sill of the window.

It will thus be appreciated that the described apparatus presents a means to assist in the raising or lowering of a roller shade, particularly shades that are cordless and that are mounted at a significant height. A simple insertion of engagement head 17 into opening 18 of grab plate 7 is all that is required in order to move bottom bar 4 in an upward direction. Similarly, insertion of engagement head 17 into opening 18 of grab plate 7, followed by an approximate 90° rotation of the wand is all that is required in order to apply a downward force to bottom bar 4. Lower and upper clips 9 and 10 of the grab plate allow it to be easily secured to a bottom bar of a roller blind during its manufacturer or during installation, and also present an easy means for retrofitting existing blinds that are currently in operation.

It is to be understood that what has been described are the preferred embodiments of the invention. The scope of the claims should not be limited by the preferred embodiments set forth above, but should be given the broadest interpretation consistent with the description as a whole.

What is claimed is:

1. An apparatus to assist in the raising or lowering of a roller shade, the apparatus comprising:
a grab plate that is secured or securable to a bottom bar of the roller blind;
a wand that is releasably securable to the grab plate,
the grab plate comprising a receiver to releasably receive an upper end of the wand such that when the upper end of the wand is moved vertically upward the roller shade is retracted, and when the wand is moved vertically downwardly the roller shade is lowered;
the receiver comprising a mating surface against which a flange on the upper end of the wand bears when the wand is moved vertically upward, the receiver further comprising a retainer into which a locking member on the upper end of the wand is seatable when the wand is moved vertically downward.

2. The apparatus as claimed in claim 1, wherein the upper end of the wand includes an engagement head that is receivable through an opening in the grab plate.

3. The apparatus as claimed in claim 2, wherein the locking member comprises one or more locking tabs that extend outwardly from the engagement head.

4. The apparatus as claimed in claim 3, wherein the retainer comprises one or more slots that are shaped to releasably receive the one or more locking tabs.

5. The apparatus as claimed in claim 4, wherein the one or more locking tabs comprise a locking bar secured generally perpendicular to a longitudinal axis of the engagement head, the locking bar having at least one end extending beyond an outer surface of the engagement head and seatable within one of the one or more slots such that a downward force applied to the wand is transmitted through the at least one end of the locking bar to the grip plate, causing the roller shade to be lowered.

6. The apparatus as claimed in claim 2, wherein the flange is positioned longitudinally below the engagement head and engages the mating surface of the grip plate when the engagement head is received through the opening in the grab plate and the wand is moved vertically upward.

7. The apparatus as claimed in claim 5, wherein the opening in the grab plate has a major axis and a minor axis, the major axis being larger than the minor axis, the major axis dimensioned to permit the passing of the locking bar through the opening when the locking bar is generally aligned with the major axis.

8. The apparatus as claimed in claim 7, wherein the minor axis is dimensioned to prevent passage of the locking bar through the opening when the locking bar is generally aligned with the minor axis.

9. The apparatus as claimed in claim 1, wherein the grab plate comprises an upper and a lower clip member, the upper and lower clip members releasably securable to the bottom bar of the roller shade.

10. An apparatus to assist in the raising or lowering of a roller shade, the apparatus comprising:
a grab plate, the grab plate secured or securable to a bottom bar of the roller blind;
a wand, the wand releasably securable to the grab plate,
the grab plate comprising a receiver to releasably receive an upper end of the wand such that when the upper end of the wand is moved vertically upward the roller shade is retracted, and when the wand is moved vertically downwardly the roller shade is lowered;
the receiver comprising a mating surface against which a flange on the upper end of the wand bears when the wand is moved vertically upward, the receiver further comprising a retainer into which a locking member on the upper end of the wand is seatable when the wand is moved vertically downward, the locking member comprising one or more locking tabs that extend outwardly from an engagement head on an upper end of the wand.

11. The apparatus as claimed in claim 10, wherein the retainer comprises one or more slots that are shaped to releasably receive the one or more locking tabs.

12. The apparatus as claimed in claim 11, wherein the one or more locking tabs comprise a locking bar secured generally perpendicular to a longitudinal axis of the engagement head, the locking bar having at least one end extending beyond an outer surface of the engagement head and seatable within one of the one or more slots such that a downward force applied to the wand is transmitted through the at least one end of the locking bar to the grip plate, causing the roller shade to be lowered.

13. In combination, a roller shade and an apparatus to assist in raising or lowering the roller shade in accordance with claim 1.
